(19) United States
(12) Patent Application Publication
(10) Pub. No.: US 2008/0172522 A1
(43) Pub. Date: Jul. 17, 2008

(54) INFORMATION PROCESSING APPARATUS AND INCREMENTAL WRITE TYPE FILE MANAGEMENT SOFTWARE

(75) Inventor: Takafumi ITO, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 11/972,983

(22) Filed: Jan. 11, 2008

(30) Foreign Application Priority Data
Jan. 15, 2007 (JP) 2007-006440

(51) Int. Cl. G06F 12/00

(52) U.S. Cl. 711/103; 711/E12.001

(57) ABSTRACT

An information processing apparatus has a common incremental write type file system allowing an incremental write type file access, including an incremental write type file write, to an incremental write type optical recording medium and a non-volatile semiconductor memory device.

### CROSS REFERENCE TO RELATED APPLICATION

This application is based upon and claims the benefit of priority from the prior Japanese Patent Application No. 2007-6440 filed on Jan. 15, 2007; the entire contents of which are incorporated herein by this reference.

### BACKGROUND OF THE INVENTION

1. Field of the Invention

The present invention relates to an information processing apparatus for managing an incremental write type optical recording medium and a non-volatile semiconductor memory device with a common incremental write type file management system and the incremental write type file management software.

2. Description of the Related Art

In recent years, a memory card/memory device using a NAND flash memory, for example, as a non-volatile semiconductor memory device has been widely used for a personal computer (hereinafter abbreviated as a ‘PC’) and the other information recording apparatus.

The NAND flash memory includes a plurality of memory cells arranged adjacently with a source and a drain connected in series, in which the plurality of memory cells connected in series are connected as one unit to a bit line. In the NAND flash memory, a write or read operation is performed at once for all or half of the plurality of cells arranged in a row direction.

The NAND flash memory has the following features.

The writing of data is made in a unit of page size.

The erase of data is made in a unit composed of a plurality of pages called a block, and takes a considerable time.

It is required that the writing of data is made sequentially from the top page of block within each block.

If a defect in the memory area is found in writing data, it is required to move data in a block unit to an alternative block.

Therefore, in a memory device for file storage using the NAND flash memory, the following process is performed on the memory device side.

On updating data of a block including a written page, a process called a “relocation write” is performed.

The “relocation write” involves preparing another block, erasing the block, and writing the other written page data of original block together with the write data into another block. Also, when the writing of data is not performed sequentially, it is required to perform a write process with relocation write by preparing another block.

Therefore, it may take a considerable time to write one page.

Also, a certain number of blocks are reserved as the spare blocks to be ready for the occurrence of a defective block (therefore, an available area for a user is essentially reduced by the amount of spare blocks even if no defect occurs).

At present, a FAT file system is used as a file system for making the file management of flash memory.

The FAT file system reads or writes the file data in a data unit called a cluster, in which allocation of cluster to each file is managed by a table called a FAT (File Allocation Table).

In the FAT file system, the writing into each cluster occurs randomly, and every time the writing or updating of cluster data in the file main body occurs, the rewriting of FAT data at the fixed position occurs.

Therefore, every time of writing the cluster data, the relocation write mentioned above occurs, so that the file writing or rewriting speed may decrease.

In future, as the flash memory has a larger memory capacity, there is high possibility that the block size is further greater, whereby the negative influence with the relocation write is more significant.

To improve the negative influence, a technology for applying the incremental write type file system to the flash memory was disclosed in Japanese Patent Application Laid-Open No. 2006-40264.

If such incremental write type file system or its software is applied to the NAND flash memory, the substantial NAND writing efficiency at the time of writing a file is greatly increased, and the writing speed and the NAND flash memory utilization efficiency are greatly increased.

However, in order to do so, it is required to develop the new file system or write software for the host apparatus such as PC using the NAND flash memory. Therefore, significant development costs are needed, making it difficult to apply the incremental write type file write to the NAND flash memory.

### SUMMARY OF THE INVENTION

According to one aspect of the present invention, an information processing apparatus has a common incremental write type file system allowing an incremental write type file access, including an incremental write type file write, to an incremental write type optical recording medium and a non-volatile semiconductor memory device.

According to another aspect of the invention, the incremental write type file management software for managing an incremental write type optical recording medium and a non-volatile semiconductor memory device with an incremental write type file, has the software of the common incremental write type file system allowing an incremental write type file access, including an incremental write type file write, to the incremental write type optical recording medium and the non-volatile semiconductor memory device.

### BRIEF DESCRIPTION OF THE DRAWINGS

FIG. 1 is a block diagram showing the schematic configuration of a PC that forms an information processing apparatus according to a first embodiment of the present invention;

FIG. 2 is a functional block diagram implemented by the CPU when the incremental write type file management software is loaded on the OS;

FIG. 3 is a flowchart of the operation contents capable of the incremental write type file access;

FIG. 4 is a block diagram showing the schematic configuration of a PC that forms an information processing apparatus according to a second embodiment of the present invention;

FIG. 5 is a functional block diagram implemented by the CPU when the incremental write type file management software is loaded on the OS;

FIG. 6 is a flowchart of the operation contents capable of the incremental write type file access; and

FIG. 7 is a view showing a data arrangement example of a NAND flash memory.

### DETAILED DESCRIPTION OF THE PREFERRED EMBODIMENTS

The preferred embodiments of the present invention will be described below with reference to the drawings.

### First Embodiment

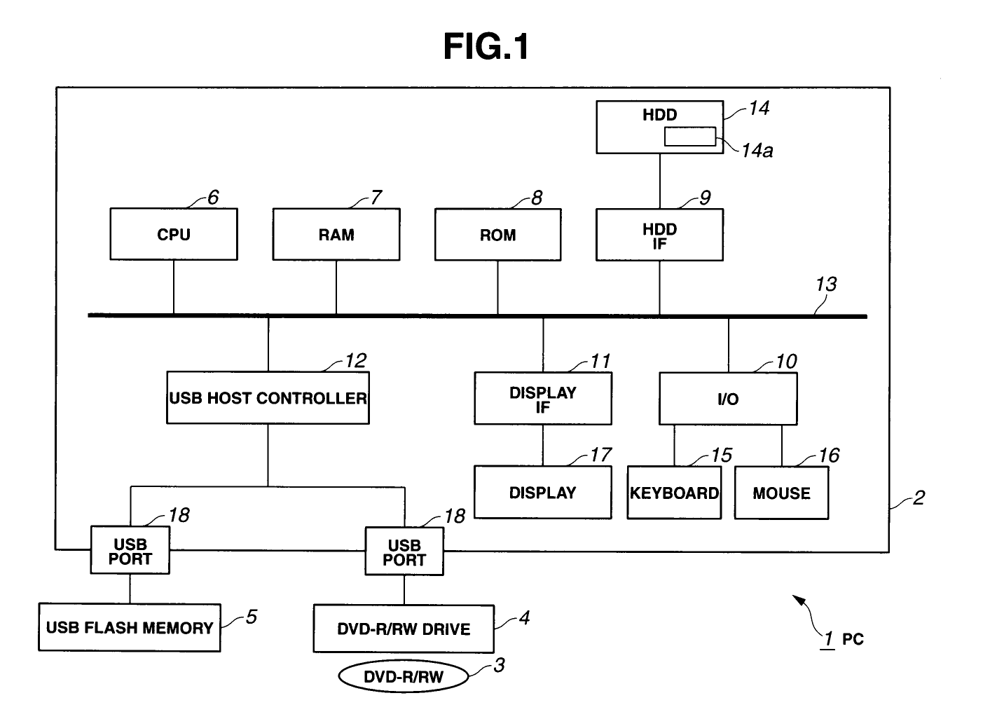

FIG. 1 shows the configuration of a personal computer 1 (hereinafter abbreviated as a ‘PC’) as an information processing apparatus according to a first embodiment of the present invention.

The PC 1 has a PC main body 2, in which a USB (Universal Serial Bus) DVD-R/RW drive unit (abbreviated simply as a DVD-R/RW drive in the figure) 4 for making the file write/file read into/from DVD (Digital Versatile Disc)-R or DVD-RW (hereinafter abbreviated as DVD-R/RW media) 3, for example, as the incremental write type optical recording medium, and a USB flash memory 5, for example, as a non-volatile semiconductor memory device are detachably connected to the PC main body 2.

Within the PC main body 2, a CPU 6 for controlling each unit, a RAM 7 for use as a work area and the like, a ROM 8 into which BIOS and the like is written, a hard disk interface (abbreviated as an ‘HDD IF’) 9, an input/output interface (abbreviated as an I/O) 10, a display IF 11 and a USB host controller 12 are connected via a bus 13.

An HDD 14 is connected to the HDD IF 9, a keyboard 15 and a mouse 16 are connected to the I/O 10, and a display 17 is connected to the display IF 11.

Also, the USB host controller 12 is provided with two USB ports 18, for example, which form a USB IF together with the USB host controller 12. And the USB devices such as the USB DVD-R/RW drive unit 4 and the USB flash memory 5 can be detachably connected to the two USB ports 18.

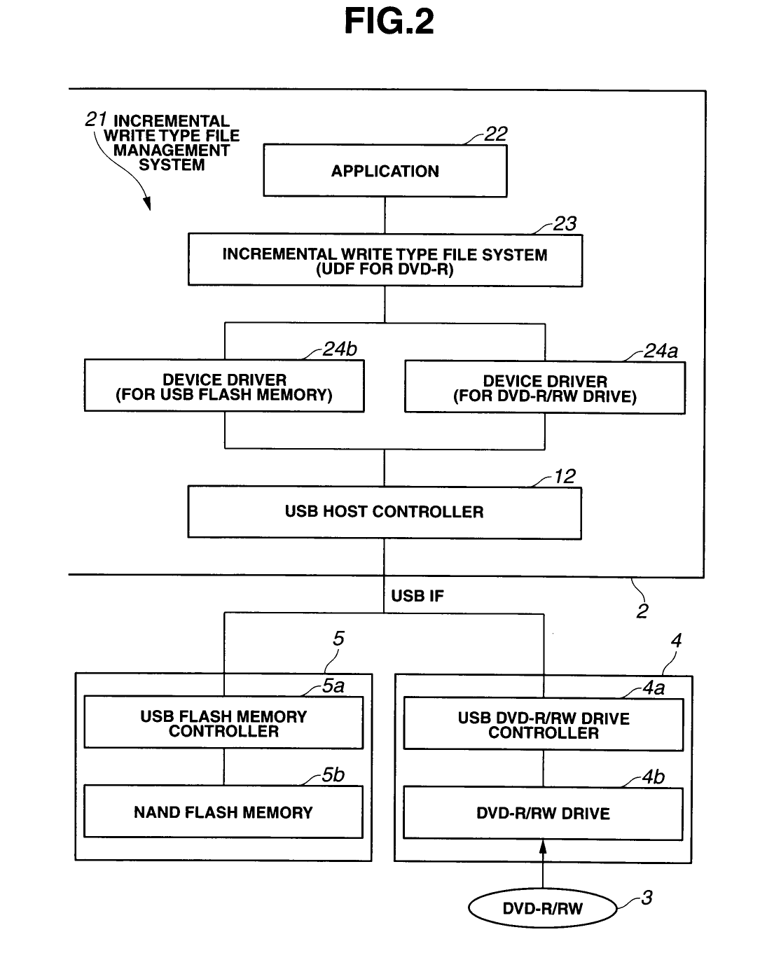

In the embodiment, the HDD 14, for example, stores the incremental write type file management software 14a that realizes an incremental write type file management system 21 as shown in FIG. 2, in addition to an OS (Operating System) as the basic software.

And the CPU 6 loads the incremental write type file management software 14a on the OS and forms the incremental write type file management system 21 that can manage the DVD-R/RW media 3 via the USB DVD-R/RW drive unit 4 and the USB flash memory 5 as the incremental write type file in the common incremental write type file system 23, as shown in the functional blocks of FIG. 2.

FIG. 2 shows only a peripheral part of the functional block managed by the incremental write type file management system 21.

The incremental write type file management system 21 as shown in FIG. 2 forms an incremental write type file system (more particularly UDF-VAT for DVD-R) 23 as an API (Application Programming Interface) processing part or middleware that receives an instruction from an application (software) 22 on the upper layer and makes an instruction of file write or file read into or from the device drivers 24a and 24b becoming the functional blocks on the lower layer, as needed.

Herein, a UDF (Universal Disk Format) is one of the sequential access formats employed for the DVD media. Also, the incremental write type file management can be performed for DVD-R media in which data cannot be rewritten by having a translation table called a VAT (Virtual Allocation Table) as the file.

The application 22 consists of the writing software for making the writing and the ordinary application software. More specifically, the device drivers 24a and 24b are a device driver for the USB DVD-R/RW drive unit and a device driver for the USB flash memory.

The device driver 24a issues a DVD-R command to the USB DVD-R/RW drive unit 4 via the USB host controller 12. Also, the device driver 24b issues a command to the USB flash memory 5 via the USB host controller 12.

In FIG. 2, the USB DVD-R/RW drive unit 4 detachably connected via the USB IF includes a USB DVD-R/RW drive controller 4a and a DVD-R/RW drive 4b controlled by the USB DVD-R/RW drive controller 4a.

And using the common incremental write type file system 23 makes the incremental write type write (i.e., file write) in the DVD-R/RW media 3 possible to be mounted on the USB DVD-R/RW drive 4b, and the file once written on the DVD-R/RW media to be read, namely, the incremental write type file to be accessed for reading the file.

Also, the USB flash memory 5 detachably connected via the USB IF includes a USB flash memory controller 5a and a NAND flash memory 5b controlled by the USB flash memory controller 5a. And using the common incremental write type file system 23 makes the incremental write type file possible to be accessed for the incremental write type file write or file read into or from the NAND flash memory 5b.

In the manner, the common incremental write type file system 23 that allows the incremental write type file access to the DVD-R/RW media 3 and the USB flash memory 5 mounted on the USB DVD-R/RW drive 4b is formed in the embodiment.

There is a merit that the application 22 can be commonly used by forming the common incremental write type file system 23.

In the manner, by forming the common incremental write type file system 23, the development cost for software can be smaller than that of forming separately the incremental write type file system.

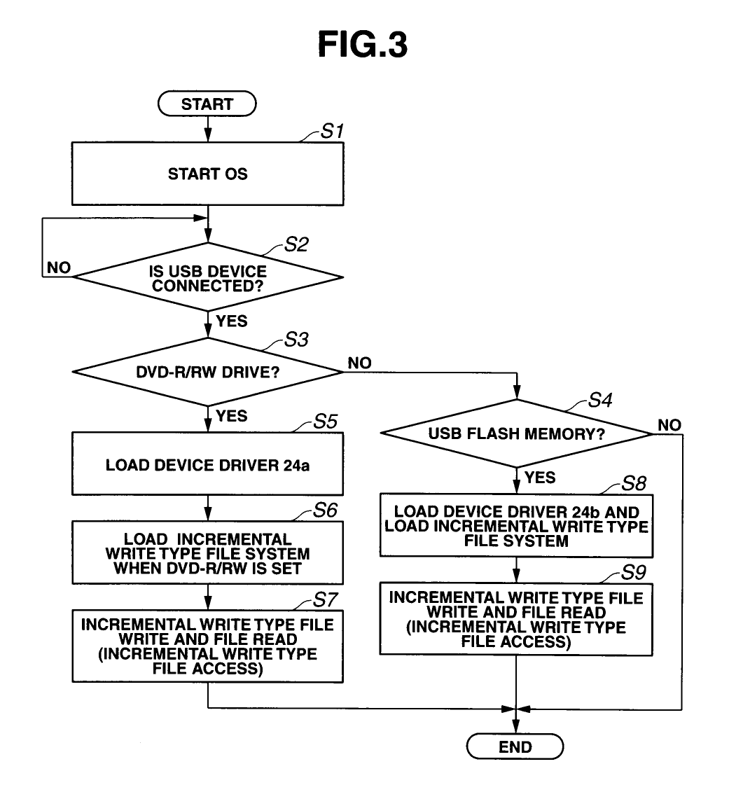

Referring to a flowchart of FIG. 3, the operation of making the incremental write type file access to the DVD-R/RW media 3 and the USB flash memory 5 with the incremental write type file management system 21 having the common incremental write type file system 23 will be described below.

In the following, an operation example is given in which at least one of the USB DVD-R/RW drive unit 4 and the USB flash memory 5 is connected to the PC main body 2, and if the USB DVD-R/RW drive unit 4 is connected, and the DVD-R or DVD-RW is further set, the incremental write type file access is allowed.

When the power of the PC main body 2 is turned on, the CPU6 starts the OS by loading the OS software from the HDD 14 at step S1. Also, the CPU 6 loads a part of the software forming the application 22 on the OS.

At the next step S2, the USB host controller 12 recognizes whether or not the USB device such as the external USB DVD-R/RW drive unit 4 and the USB flash memory 5 is connected to the USB port 18.

If the USB device is not connected, the operation waits for the USB device to be connected, or the process of FIG. 3 is ended. And if the USB device is connected, an identification of whether the connected USB device is USB DVD-R/RW drive unit 4 or USB flash memory 5 is made based on the USB device ID as shown at steps S3 and S4.

If the USB DVD-R/RW drive unit 4 is connected, the information is passed to the CPU 6 forming the OS. As shown at step S5, the CPU 6 forming the OS loads the software of the device driver 24a for the USB DVD-R/RW drive unit.

Also, as shown at step S6, if the DVD-R or DVD-RW is set (mounted) on the USB DVD-R/RW drive unit 4, the CPU 6 forming the OS loads the software of the incremental write type file system 23. And the incremental write type file system 23 forming the incremental write type file management system 21, more specifically, the incremental write type file system (supporting UDF-VAT for DVD-R) 23 capable of the incremental write type file write (writing) is formed on the OS, as shown in FIG. 2.

Thereby, it is possible to make access to the USB DVD-R/RW drive unit 4 via the incremental write type file system 23 and the device driver 24a from the software of the application 22. And it is possible to make the incremental write type file write into the DVD-R or DVD-RW set on the USB DVD-R/RW drive unit 4 as shown at step S7.

Similarly, it is possible to make the file reading of the DVD-R or DVD-RW set on the USB DVD-R/RW drive unit 4 via the incremental write type file system 23 and the device driver 24a from the software of the application 22.

Namely, it is possible to make the incremental write type file access to the DVD-R or DVD-RW as indicated within parentheses at step S7.

On the other hand, if it is recognized that the USB flash memory 5 is connected to the USB port 18 at step S4, the CPU 6 forming the OS loads the software of the device driver 24b for USB flash memory and the software of the incremental write type file system 23 common to the DVD-R/RW media 3 as shown at step S8.

And as shown at the next step S9, the incremental write type (UDF-VAT for DVD-R) file writing is made in the NAND flash memory 5b by making access to the USB flash memory 5 via the incremental write type file system 23 and the device driver 24b from the software of the application 22.

Similarly, the file reading is made from the NAND flash memory 5b of the USB flash memory 5 via the incremental write type file system 23 and the device driver 24b from the software of the application 22. Namely, it is possible to make the incremental write type file access to the USB memory (using the incremental write type file system 23 common to the DVD-R/RW media 3) as indicated within parentheses at step S9.

If any USB device other than the USB flash memory 5 is connected at step S4, the process of FIG. 3 is ended.

For the sake of simplicity, the operation where one of the USB DVD-RIRW drive unit 4 and the USB flash memory 5 is connected to the USB port 18 is shown in FIG. 3, but the operation where both are connected can be also handled.

For example, when the USB flash memory 5 is connected after the USB DVD-R/RW drive unit 4 is connected to the USB port 18, the device driver 24b alone is loaded, because the software of the incremental write type file system 23 is already loaded.

And the incremental write type file access is allowed to both media of the DVD-R/RW media 3 and the USB flash memory 5.

Also, when the USB flash memory 5 is connected before the USB DVD-R/RW drive unit 4 is connected to the USB port 18, the device driver 24a is only loaded, because the software of the incremental write type file system 23 is already loaded.

Thus, in the embodiment, the substantial NAND write efficiency of file write (at the time of writing) into the non-volatile NAND semiconductor memory device using the NAND flash memory 5b can be increased by using the incremental write type file system 23, whereby the write speed and the NAND utilization efficiency can be increased.

Also, the incremental write type file write software or file system common to the existent optical media, such as the incremental write type packet write software for DVD-R/RW, can achieve the following.

By making the incremental write type write into the flash memory device (non-volatile semiconductor memory device) such as the USB flash memory 5, the efficient file write into the flash device can be realized with lower software development and packaging costs.

### Second Embodiment

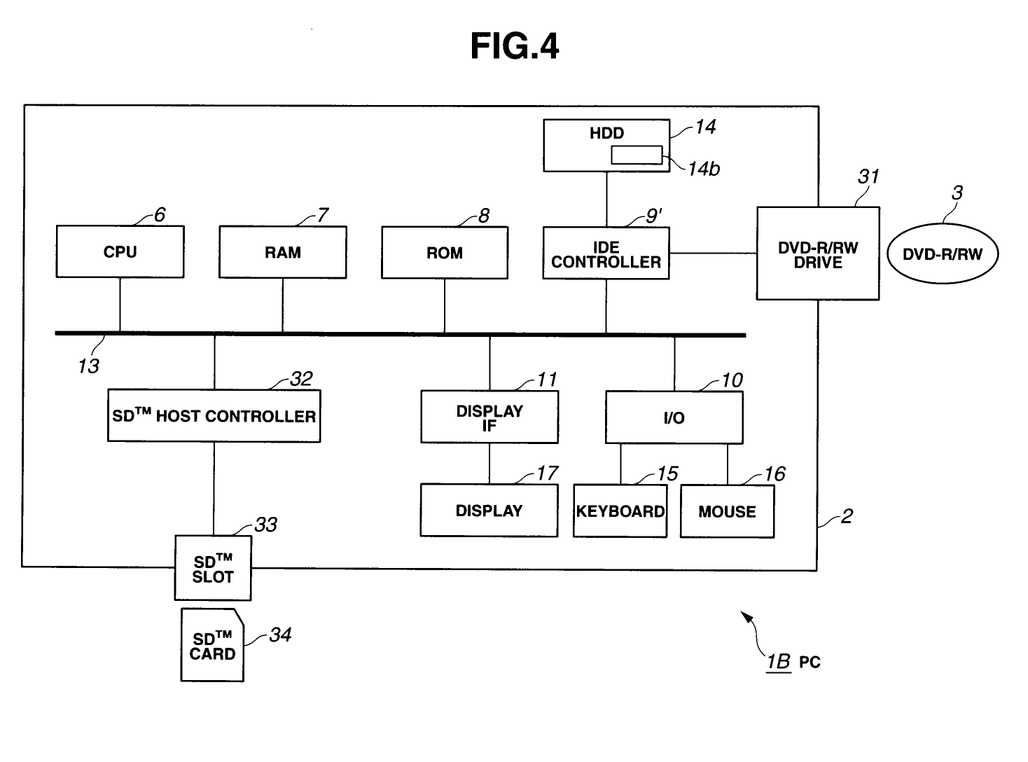

FIG. 4 shows the configuration of a PC 1B as an information processing apparatus according to a second embodiment of the present invention. The PC 1B has an IDE (ATARI) controller 9′, for example, instead of the HDD IF 9 within the PC main body 2 in the PC 1 of FIG. 1. An HDD 14 for IDE connection and a DVD-R/RW drive unit 31 for IDE connection are connected to the IDE controller 9′.

And the user can detachably set the DVD-R/RW media 3 on the DVD-R/RW drive unit 31 in the same manner as in the first embodiment.

Also, the PC 1B is provided with an SD™ host controller 32, instead of the USB host controller 12 within the PC main body 2 in the PC 1 of FIG. 1, and an SD™ slot 33 is connected to an SD™ card bus of the SD™ host controller 32.

And the user can connect detachably an SD™ card 24 to the SD™ slot 33.

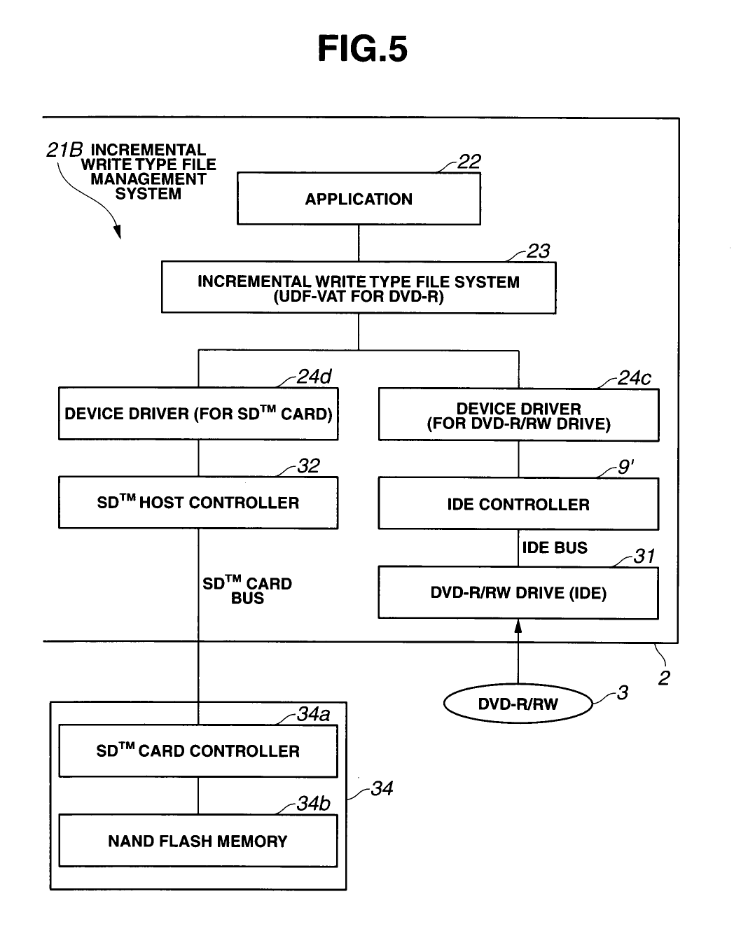

Also, in the embodiment, the incremental write type file management software 14b constituting an incremental write type file management system 21B (see FIG. 5) including the incremental write type file system 23 as described in the first embodiment is stored in the HDD 14, for example.

And the CPU 6 loads the incremental write type file management software 14b on the OS, thereby forming the incremental write type file management system 21B as shown in the functional blocks of FIG. 5.

In the incremental write type file management system 21B, the common incremental write type file system 23 is formed in the same manner as that in the first embodiment.

And if the DVD-R/RW media 3 is set on the DVD-R/RW drive unit 31, the incremental write type file write and file read can be made from the application 22 via the incremental write type file system 23 and the device driver 24c.

Also, if the SD™ card 34 is connected to the SD™ slot 33, it is possible to make the incremental write type file write and file read from the application 22 via the incremental write type file system 23 and the device driver 24d.

More specifically, the device drivers 24c and 24d are a device driver of IDE connection for a DVD-R/RW drive and a device driver for SD™ card. In the embodiment, the DVD-R/RW drive unit 31 for IDE connection is provided in the PC main body 2, as shown in FIG. 4. Accordingly, when the OS is started, the device driver 24c can be loaded on the OS, as described below.

Also, the SD™ card 34 has an SD™ card controller 34a connected via the SD™ card bus to the SD™ host controller 32, and a NAND flash memory 34b, as shown in FIG. 5. The NAND flash memory 34b may be the same as the NAND flash memory 5b of the first embodiment.

In the embodiment as described above, the software development costs can be also reduced by forming the common incremental write type file system 23 same as in the first embodiment.

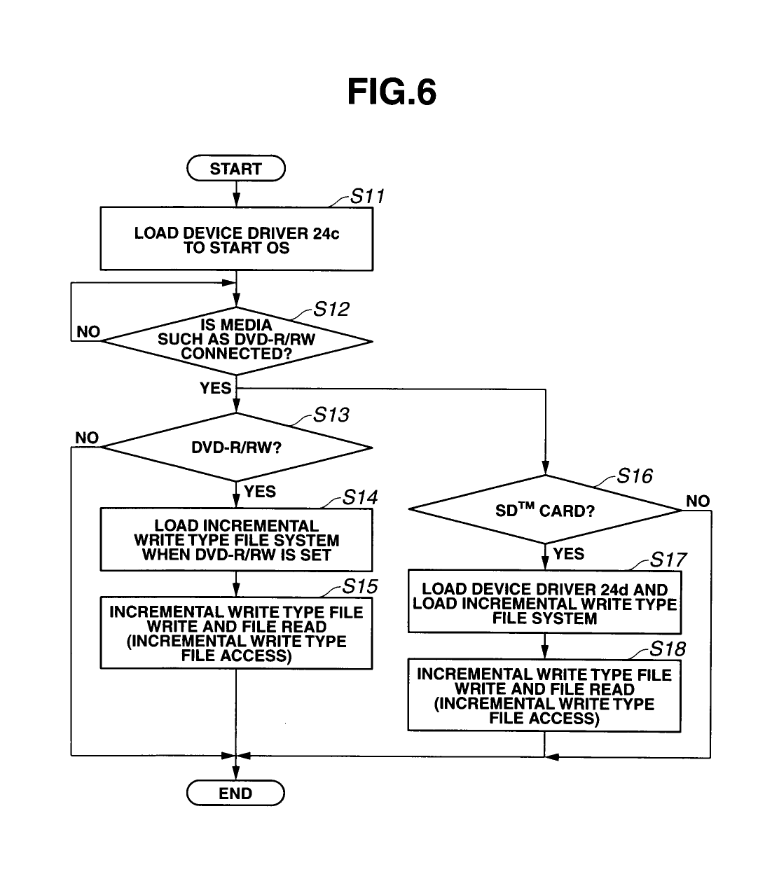

The operation of the incremental write type file management system 21B according to the embodiment will be described below. FIG. 6 is a flowchart of an operation procedure for making the incremental write type file access to the DVD-R/RW media 3 and the SD™ card 34 in the incremental write type file management system 21B having the common incremental write type file system 23.

When the power of the PC main body 2 is turned on, the CPU 6 starts the OS by loading the OS software from the HDD 14 as shown at step S11. Since the DVD-R/RW drive unit 31 is built in the PC main body 2, the device driver 24c of IDE connection for DVD-R/RW drive is loaded when the OS is started.

At the next step S12, the operation waits for the media such as the DVD-R/RW media 3 or the SD™ card 34 to be set.

If the media is connected, it is determined at step S13 whether or not the DVD-R/RW media 3 is set. If the media is not the DVD-R/RW media 3, the process of FIG. 6 is ended.

When the DVD-R/RW media 3 is set, the incremental write type file system (supporting the UDF-VAT for DVD-R) 23 is loaded on the OS as shown at step S14.

And it is possible to make access to the DVD-R/RW drive unit 31 via the incremental write type file system 23 and the device driver 24c from the application 22 on the OS, and make the incremental write type (UDF-VAT for DVD-R) file write to the DVD-R media or DVD-RW media set on the DVD-R/RW drive unit 31 as shown at step S15.

Similarly, it is possible to make the file read from the DVD-R media or DVD-RW media set on the DVD-R/RW drive unit 31 via the incremental write type file system 23 and the device driver 24c from the application 22. Namely, the incremental write type file becomes accessible.

On the other hand, the media connected to the PC main body 2 is detected at step S12, and it is determined whether or not the media is the SD™ card 34 as shown at step S16. If the media is not the SD™ card 34, the process of FIG. 6 is ended.

And if it is determined that the SD™ card 34 is set, the device driver 24d for SD card and the incremental write type file system (supporting UDF-VAT for DVD-R) 23 (common to DVD-R/RW) can be loaded on the OS as shown at step S117.

And it is possible to make access to the SD™ card 34 via the incremental write type file system 23 and the device driver 24d from the software of the application 22 on the OS, and make the incremental write type (UDF-VAT for DVD-R) file write into the SD™ card 34 as shown at step S18.

Similarly, it is possible to make the file read from the SD card 34 via the incremental write type file system 23 and the device driver 24d from the software of the application 22. Namely, the incremental write type file becomes accessible.

The second embodiment has the almost same effects as those in the first embodiment.

The software of the incremental write type file system 23 may include a part of the process unique to each device for the NAND flash memory and the DVD-R/RW, for example, as the non-volatile semiconductor memory device.

In other words, the common incremental write type file system 23 may change a part of the file access parameters (packet size in DVD-R/RW media 3 as a specific example) between the case of making the incremental write type file access to the incremental write type optical recording medium (DVD-R/RW media 3 in the specific example) and the case of making the incremental write type file access to the non-volatile semiconductor memory device (NAND flash memory in the specific example).

For example, for the NAND flash memory, the packet size of a write unit according to the UDF standard for DVD-R/RW may be changed.

Note that, under the UDF standard, the packet is a writable minimum unit. In addition, the sector is a minimum unit for file management. The packet size is an integral multiple of the sector size.

For the DVD-R/RW, the packet size is fixed to 64 KB (Bytes). On the contrary, for the flash memory, the page size is a write unit, whereby the integral multiple (integer of 2 or greater including 1) of the page size may be the minimum write unit, efficiently making the writing.

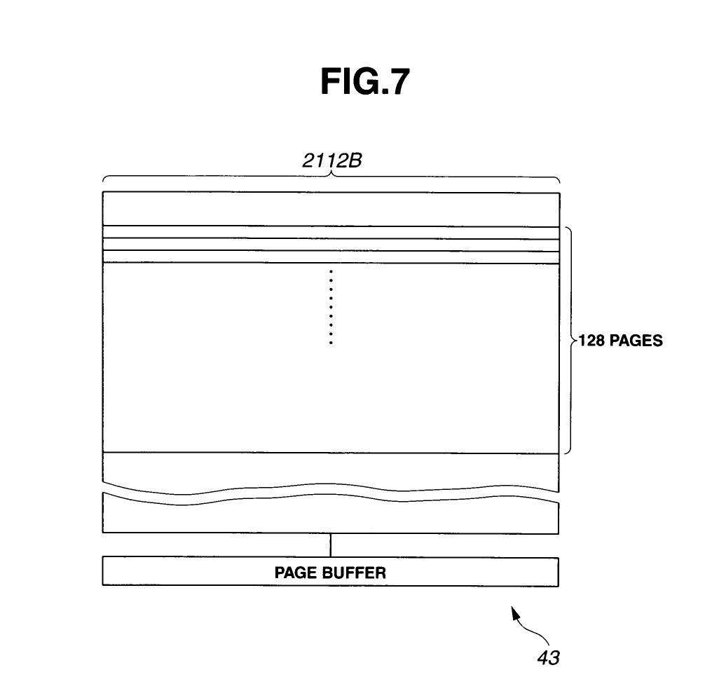

FIG. 7 shows a data arrangement of the NAND flash memory 43 in the case where the page size is different from the write unit according to the UDF standard for the DVD-R/RW.

The write page size (recording unit area) of the NAND flash memory 43 is 2112 B (data recording part of 512 B×4+redundant part of 10 B×4+management data recording part of 24 B), for example, and 128 pages is one erase unit (i.e., 256 KB+8 KB), for example. In the following explanation, for the sake of convenience, the erase unit of the flash memory is 256 KB.

Also, the NAND flash memory 43 has a page buffer for making the input/output of data into/from the NAND flash memory 43. The recording capacity of the page buffer is 2112 B (2048 B+64 B), for example. In writing the data, the page buffer performs a data input/output process for the NAND flash memory in units of page corresponding to its own recording capacity.

In an example of FIG. 7, the page size is smaller than the packet size for DVD-R/RW, but may be set to 64 KB that is the packet size for DVD-R/RW.

A smaller packet size enables more detailed file management and high efficiency in file management. Using a value that is an integral multiple of the page size (2 KB, 4 KB, 8 KB, or the like) and smaller than 64 KB as the packet size for the flash memory allows an access with high file management efficiency and good write efficiency of the NAND flash memory.

Though the efficiency of access to the flash memory is reduced, if more emphasis is placed on the file management efficiency, the packet size may be set to 512 Byte that is the minimum access unit of an SD™ card interface.

Thus, it is possible to select an appropriate packet size for the flash memory depending on the purpose of use.

In the future, when the page size of the NAND flash memory is increased to 128 KB, the incremental write type file access for NAND flash memory may be made by writing in a unit of packet size of 128 KB or its integral multiple.

In the manner, the file access parameter may be set according to the page size of the NAND flash memory 43 in such a manner that the minimum write unit is its integral multiple. Then, the writing can be efficiently performed.

It is effective that the parameter for packet size (write size) is set according to the page size of the flash memory, not only when the drive unit for DVD-R/RW exists, but also when the drive unit for DVD-R/RW does not exist.

In the case, the efficient file write/rewrite to the NAND flash memory 43 can be implemented with lower software development costs.

The sector that is the minimum unit for file management in the UDF standard may be changed between the DVD-R/RW and the flash memory. Under the UDF standard for the DVD-R/RW, the sector size for the DVD-R/RW is defined as 2 KB due to the characteristic of the DVD-R/RW.

Reducing further the sector size enables a more detailed and efficient file management. The sector size for the flash memory may be set to 512 Byte that is the sector size of SD™ card interface, for example.

Alternatively, if more emphasis is placed on the efficiency to access the NAND flash memory according to the characteristics of the NAND flash memory, the sector size may be increased to be larger than 2 KB and to be an integral multiple of the page size of the NAND flash memory (if the page size is 4 KB, the sector size may be 4 KB), for example.

Thus, it is possible to select an appropriate sector size for the flash memory depending on the purpose of use.

In addition to the configurations as described in the above embodiments, access to the SD™ card 34 may be made via a memory card reader writer for USB connection, instead of the SD™ slot 33 built in the PC main body 2 of the second embodiment, for example.

Having described the preferred embodiments of the invention referring to the accompanying drawings, it should be understood that the present invention is not limited to those precise embodiments and various changes and modifications thereof could be made by one skilled in the art without departing from the spirit or scope of the invention as defined in the appended claims.

What is claimed is:

1. An information processing apparatus comprising a common incremental write type file system allowing an incremental write type file access, including an incremental write type file write, to an incremental write type optical recording medium and a non-volatile semiconductor memory device.

2. The information processing apparatus according to claim 1, wherein said common incremental write type file system changes a part of the file access parameters between the case of making the incremental write type file access to said incremental write type optical recording medium and the case of making the incremental write type file access to said non-volatile semiconductor memory device.

3. The information processing apparatus according to claim 1, wherein said non-volatile semiconductor memory device is formed using a flash memory.

4. The information processing apparatus according to claim 2, wherein said non-volatile semiconductor memory device is formed using a flash memory.

5. The information processing apparatus according to claim 2, wherein said parameter is a packet size, and said common incremental write type file system uses a different packet size in making the file access to said semiconductor memory device from the packet size of 64 kbytes in making the file access to said incremental write type optical recording medium.

6. The information processing apparatus according to claim 1, further comprising the functional blocks of a device driver for optical recording medium for operating said incremental write type optical recording medium and a device driver for semiconductor memory device for operating said non-volatile semiconductor memory device.

7. The information processing apparatus according to claim 2, further comprising the functional blocks of a device driver for optical recording medium for operating said incremental write type optical recording medium and a device driver for semiconductor memory device for operating said non-volatile semiconductor memory device.

8. The information processing apparatus according to claim 1, wherein said common incremental write type file system is the file system employing a UDF (Universal Disk Format) of sequential access format employed in a DVD recording medium, and a VAT (Virtual Allocation Table) as a translation table.

9. The information processing apparatus according to claim 2, wherein said common incremental write type file system is the file system employing a UDF (Universal Disk Format) of sequential access format employed in a DVD recording medium, and a VAT (Virtual Allocation Table) as a translation table.

10. The information processing apparatus according to claim 1, wherein a USB (Universal Serial Bus) interface is provided as the interface for at least one of said optical recording medium and said semiconductor memory device.

11. The information processing apparatus according to claim 1, wherein an IDE (Integrated Drive Electronics) interface is provided as the interface for said optical recording medium.

12. The information processing apparatus according to claim 3, wherein in making an incremental write type file access to said NAND flash memory in which the writing of data is performed an unit of predetermined memory area called a page size, a parameter in which the integral multiple of said page size is the minimum write unit is used.

13. The information processing apparatus according to claim 1, further comprising a drive unit for making the file write/file read into/from the DVD-R or DVD-RW as said optical recording medium.

14. The information processing apparatus according to claim 1, wherein said information processing apparatus is provided in a personal computer having a CPU (Central Processing Unit) at least.

15. The information processing apparatus according to claim 1, wherein said common incremental write type file system is formed by a CPU (Central Processing Unit) loading the software forming said common incremental write type file system in a state where an OS (Operating System) is started or new device is plugged.

16. The information processing apparatus according to claim 2, wherein said common incremental write type file system changes a size of a sector which is a minimum unit for file management, as said parameter, between said non-volatile semiconductor memory device and said incremental write type optical recording medium.

17. The information processing apparatus according to claim 1, wherein said non-volatile semiconductor memory device is formed using a flash memory, and said common incremental write type file system uses, for said flash memory, a value same as a minimum access unit of the flash memory or a value of an integral multiple of the minimum access unit, as a size of a sector which is a minimum unit for file management.

18. An incremental write type file management software for managing an incremental write type optical recording medium and a non-volatile semiconductor memory device with an incremental write type file, comprising a software of a common incremental write type file system allowing an incremental write type file access, including an incremental write type file write, to said incremental write type optical recording medium and said non-volatile semiconductor memory device.

19. The incremental write type file management software according to claim 18, wherein said common incremental write type file system changes a part of the file access parameters between the case of making the incremental write type file access to said incremental write type optical recording medium and the case of making the incremental write type file access to said non-volatile semiconductor memory device.

20. The incremental write type file management software according to claim 19, wherein said parameter is a packet size.

21. The incremental write type file management software according to claim 18, wherein said common incremental write type file system is the file system employing a UDF (Universal Disk Format) of sequential access format employed in the DVD recording medium, and a VAT (Virtual Allocation Table) as a translation table.

22. The incremental write type file management software according to claim 20, wherein in the case of making an incremental write type file access to a NAND flash memory in which the writing of data is made in a unit of predetermined memory area referred to as a page size, said semiconductor memory device uses a parameter for a packet size in which an integral multiple of said page size is a minimum write unit.
